(19) United States
(12) Patent Application Publication
(10) Pub. No.: US 2023/0316360 A1
(43) Pub. Date: Oct. 5, 2023

(54) Maintenance Work Pricing Using Map Data

(71) Applicant: YSOD, Inc., Waddell, AZ (US)

(72) Inventors: Stephen Orr, Phoenix, AZ (US); Jason Turnquist, Phoenix, AZ (US)

(21) Appl. No.: 17/713,188

(22) Filed: Apr. 4, 2022

(51) Int. Cl. G06Q 30/06

(52) U.S. Cl. CPC G06Q 30/0611

(57) ABSTRACT

A system and method are disclosed to estimate maintenance work prices using map data. Embodiments include a computer-implemented method comprising receiving, at an application system a computing device associated with a customer, a request to register a property for landscaping services and determining based on address input received from the computing device associated with the customer, map data associated with the property. The method further comprises determining a service area associated with property based on the map data associated with the property and calculating a landscaping service price estimate based on the service area associated with the property. The method further comprises transmitting a job request including the landscaping service price estimate to a landscaping job queue and receiving, from a computing device associated with a landscaper, a confirmation to accept the job request.

### TECHNICAL FIELD

The present disclosure relates generally to services to connect maintenance workers to client and specifically to using map data to provide pricing quotes for such services.

### BACKGROUND

Historically, the landscaping industry has been based on non-computerized promotion and organization, such as grassroots marketing, cash payments and coordination of services using phone calls. Connected or technological solutions have been avoided because of the difficulties in connecting landscapers and homeowners in an on-demand approach. Further, landscaping technology presents difficulties in automating the estimation process for landscaping services, providing transparency for the services and automating the payment process away from cash payments, all of which are undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a maintenance work scheduling system, in accordance with a first embodiment;

FIG. 2 illustrates the application system of FIG. 1 in greater detail, in accordance with an embodiment;

FIG. 3 illustrates an exemplary method for determining a pricing estimate for maintenance work based on map data;

FIG. 4 illustrates an exemplary method for executing a maintenance work scheduling service application;

FIG. 5 illustrates an area calculation screen of the application according to an embodiment;

FIG. 6 illustrates a property detail screen of the application, according to an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

Embodiments of the following disclosure provide a system and method for providing a pricing estimate for maintenance work (such as landscaping or other yard service work) by using map data or other geolocation data. An application for such purpose is provided to mobile devices of a customer and a professional, respectively. The customer application allows the customer to select an address for service using map data, such as aerial photographs, or other geolocation data. Then, the application determines a square footage of a service area using map data, and determines a pricing estimate for the maintenance work based on this square footage. The application then generates a job request based on the square footage and the pricing estimate, and adds this job request for a job queue which can be viewed by the professional application. The professional application can then be used to select the job request from the job queue and accept the job request, which transmits a notification to the customer device indicating that the job request has been accepted and that the maintenance work may begin shortly.

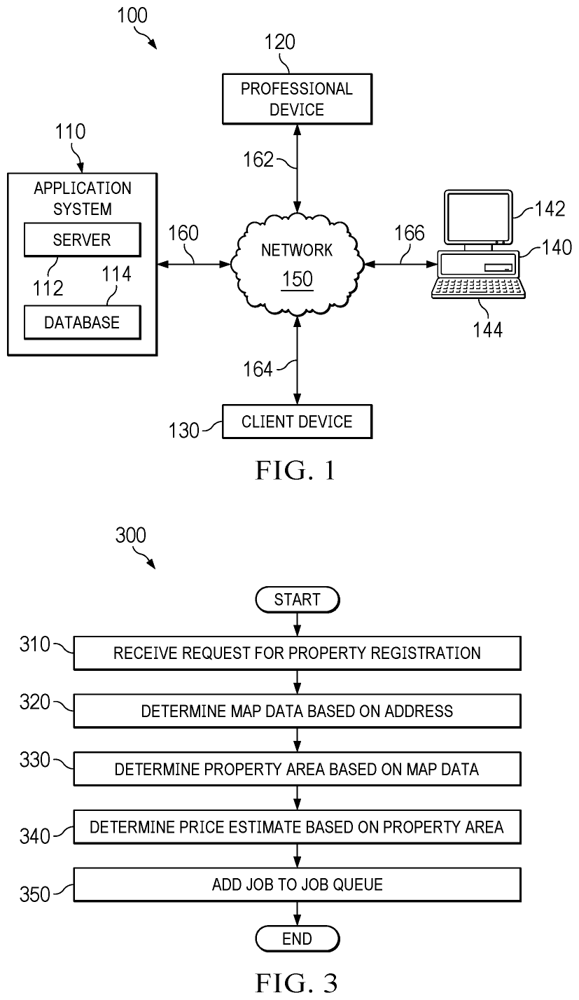

FIG. 1 illustrates maintenance work scheduling system 100, in accordance with a first embodiment. Maintenance work scheduling system 100 comprises application system 110, professional device 120, client device 130, computer 140, network 150, and communication links 160-166. Although a single application system 110, a single professional device 120, a single client device 130, a single computer 140, and a single network 150 are shown and described, embodiments contemplate any number of application systems 110, professional devices 120, client devices 130, computers 140, or networks 150, according to particular needs.

In one embodiment, application system 110 comprises server 112 and database 114. Server 112 comprises one or more modules that generate pricing estimates for maintenance work based on map data, and communicate with professional device 120 and client device 130. Database 114 comprises data corresponding to these activities, including map data and pricing data. Application system 110 communicates with client device 130 to receive a request for service, and, using an address for a property associated with client device 130, determines an area for the property, and determines a pricing estimate for the maintenance work at the property. Application system 110 thereafter may transmit a job request including the pricing estimate to professional device 120.

Professional device 120 is a device associated with one or more maintenance professionals, such as a landscaper or landscaping service. Professional device 120 may install an application that allows professional device 120 to communicate with the application server, in particular to receive and accept job requests as described in further detail below. In an embodiment, professional device 120 may be a mobile phone. In other embodiments, professional device 120 may be any computing device, such as a desktop computer or laptop computer.

Client device 130 is a computing device associated with one or more clients seeking maintenance work, such as a homeowner or home renter. Client device 130 may install an application that allows client device 130 to communicate with the application server, in particular to generate requests for maintenance work at the client's property, as described in further detail below. In an embodiment, client device 130 may be a mobile phone. In other embodiments, client device 130 may be any computing device, such as a desktop computer or laptop computer.

As shown in FIG. 1, maintenance work scheduling system 100 comprising application system 110, professional device 120 and client device 130 may operate on one or more computers 140 that are integral to or separate from the hardware and/or software that support application system 110, professional device 120 and client device 130. One or more computers 140 may include any suitable input device 144, such as a keypad, mouse, touch screen, microphone, or other device to input information. Output device 142 may convey information associated with the operation of maintenance work scheduling system 100, including digital or analog data, visual information, or audio information. One or more computers 140 may include fixed or removable computer-readable storage media, including a non-transitory computer readable medium, magnetic computer disks, flash drives, CD-ROM, in-memory device or other suitable media to receive output from and provide input to maintenance work scheduling system 100.

One or more computers 140 may include one or more processors and associated memory to execute instructions and manipulate information according to the operation of maintenance work scheduling system 100 and any of the methods described herein. In addition, or as an alternative, embodiments contemplate executing the instructions on one or more computers that cause one or more computers 140 to perform functions of the method. An apparatus implementing special purpose logic circuitry, for example, one or more field programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, maintenance work scheduling system 100 may comprise a cloud-based computing system, including but not limited to serverless cloud computing, having processing and storage devices at one or more locations, local to, or remote from application system 110, professional device 120, client device 130 and computer 140. In addition, each of the one or more computers 140 may be a work station, personal computer (PC), network computer, notebook computer, tablet, personal digital assistant (PDA), cell phone, telephone, smartphone, wireless data port, augmented or virtual reality headset, or any other suitable computing device.

In one embodiment, application system 110, professional device 120 and client device 130, and computer 140 may be coupled with network 150 using one or more communication links 160-166, which may be any wireline, wireless, or other link suitable to support data communications between application system 110, professional device 120 and client device 130, computer 140, and network 150 during operation of maintenance work scheduling system 100. Although communication links 160-166 are shown as generally coupling application system 110, professional device 120 and client device 130, and computer 140 to network 150, any of application system 110, professional device 120 and client device 130, and computer 140 may communicate directly with each other, according to particular needs.

In another embodiment, network 150 includes the Internet and any appropriate local area networks (LANs), metropolitan area networks (MANs), or wide area networks (WANs) coupling application system 110, professional device 120, client device 130, and computer 140. For example, data may be maintained locally to, or externally of, application system 110, professional device 120, client device 130, and computer 140 and made available to one or more associated users of application system 110, professional device 120, client device 130, and computer 140 using network 150 or in any other appropriate manner. For example, data may be maintained in a cloud database at one or more locations external to application system 110, professional device 120, client device 130, and computer 140 and made available to one or more associated users of application system 110, professional device 120, client device 130, and computer 140 using the cloud or in any other appropriate manner. Those skilled in the art will recognize that the complete structure and operation of network 150 and other components within maintenance work scheduling system 100 are not depicted or described. Embodiments may be employed in conjunction with known communications networks and other components.

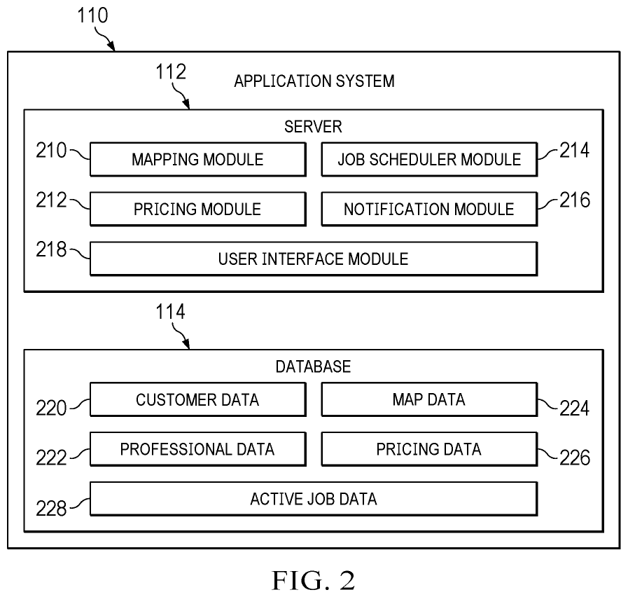

FIG. 2 illustrates application system 110 of FIG. 1 in greater detail, in accordance with an embodiment. As described above, application system 110 comprises server 112 and database 114. Although application system 110 is shown as comprising a single server 112 and a single database 114, embodiments contemplate any suitable number of servers 112 or databases 114 internal to or externally coupled with application system 110.

Server 112 of application system 110 may comprise mapping module 210, pricing module 212, job scheduler module 214, notification module 216 and user interface module 218. Although server 112 is shown and described as comprising a single mapping module 210, a single pricing module 212, a single job scheduler module 214, a single notification module 216, and a single user interface module 218, embodiments contemplate any suitable number or combination of these located at one or more locations, local to, or remote from application system 110, such as on multiple servers or computers at any location in maintenance work scheduling system 100.

According to embodiments, mapping module 210 uses customer data 220 to identify map data associated with a particular address and determine an area of a property associated with that address. In embodiments, mapping module 210 may retrieve a customer property address from customer data 220, and provide the customer property address to a mapping service application programming interface (API), the mapping service API in term providing map data for the customer property address. In embodiments, map data 224 may consist of aerial or satellite photography of the customer property address. Mapping module 210 then determines, based on map data 224, an area, such as a square footage, of a portion of the customer property, such as a yard, to additionally store as part of customer data 220.

According to embodiments, pricing module 212 generates a pricing estimate for a customer property based on an area of the customer property, such as the area generated by mapping module 210. Pricing module 212 may take into account several factors other than property area when calculating the pricing estimate, such as the number of large trees on the property, the number of medium sized trees on the property, the number of small trees on the property and the number of bushes on the property. In embodiments, pricing module 212 may use differing values for price per square inch for different situations, such as different prices for different times of day or in different geographical areas. Pricing module 212 may store the pricing estimates as pricing data 226.

According to embodiments, job scheduler module 214 generates job requests based on pricing data 226, such as the pricing estimates produced by pricing module 212. In embodiments, a job request consists of a property address, a square footage, and a pricing estimate. Job scheduler module 214 adds the job requests to a job queue, stored as active job data 228. A professional, using a professional device, may thereafter access the job request from the job queue, in order to accept the job request.

According to embodiments, notification module 216 provides notifications to a client device and a professional device based on various steps in the workflow of the application. For example, notification module 216 may provide a notification to client device 130 when a job request is accepted by professional device 120. In embodiments, notification module 216 may provide notifications via messaging protocols such as SMS or MMS. In other embodiments, notification module 216 may provide notifications via push notifications with a phone's operating system, via email, or using any other messaging method.

According to embodiments, user interface module 218 generates and displays a user interface (UI), such as, for example, a graphical user interface (GUI), that displays one or more interactive visualizations of the application. According to embodiments, user interface module 218 may display interactive graphical elements at various parts of the application, such as for accepting input. In embodiments, user interface module 218 may provide a mapping screen allowing a user to place pins on a map image to outline a maintenance area of a customer property.

Database 114 of application system 110 may comprise one or more databases or other data storage arrangement at one or more locations, local to, or remote from, server 112. Database 114 comprises, for example, customer data 220, professional data 222, map data 224, pricing data 226 and active job data 228. Although database 114 is shown and described as comprising customer data 220, professional data 222, map data 224, pricing data 226 and active job data 228, embodiments contemplate any suitable number or combination of these, located at one or more locations, local to, or remote from, application system 110 according to particular needs.

Customer data 220 includes data concerning one or more customers using the application. In embodiments, customer data 220 may include payment details of the customer, such as credit card information, a phone number of the customer for sending notifications to the customer via SMS or MMS, a name of the customer and an address of the customer. In embodiments an as described above, customer data 220 may include an area of the customer property determined by mapping module 210.

Professional data 222 includes data concerning one or more professionals using the application. In embodiments, professional data 222 may include payment receipt details for the professionals, such as bank account information for direct deposits, a phone number of the professional for sending notifications to the professional via SMS or MMS, and a location of the professional as determined by GPS data of professional device 120. In embodiments, professional data 222 may include one or more accepted jobs associated with professional device 120, that the professional has previously accepted.

Map data 224 includes map images associated with one or more customer properties, such as aerial or satellite photography. Map data 224 may include larger images cropped down to be stored saving only a portion of the image including the customer property. In one embodiment, map data 224 may be obtained from a mapping service using a mapping service API, however in other embodiments map data 224 may be stored within database 114 for use by application system 110.

Pricing data 226 includes one or more pricing estimates associated with one or more customer property addresses and based on an area of the customer property. As discussed above, pricing data 226 may be based on several factors in addition to the area of the customer property, such as the number and size of trees and bushes on the customer property as well as a geographical location of the customer property.

Active job data 228 includes a job queue of job requests added to the job queue by job scheduler module 214. As described in more detail below, once a job request has been added to the job queue, the job request becomes viewable to professional devices. A user of professional device 120 may then access the job queue in order to view job requests in more detail, and accept or decline job requests. Once a job request has been accepted by one professional device, the job request is removed from the job queue and is no longer viewable to other professional devices.

FIG. 3 illustrates exemplary method 300 for determining a pricing estimate for maintenance work based on map data. Method 300 proceeds by one or more actions, which although described in a particular order, may be performed in one or more permutations, according to particular needs.

At first action 310 of method 300, application system 110 receives, from client device 130, a request for property registration. In an embodiment, the request for property registration includes an address of the property to be registered. The request for property registration may include additional details, such as a name of the owner of the property or any other details that may be relevant to the execution of a maintenance job, such as gate codes for gated communities or codes to access back yards of homes, for example.

At second action 320 of method 300, application system 110 determines map data 224 for a particular property based on address for that property. Application system 110 may provide the address to a mapping service API in order to obtain map data for the property.

At third action 330 of method 300, application system 110 determines a property area for the property based on the map data for the property. The property area may correspond to the area that the customer is requesting maintenance work on, such as yard area excluding any structures on the property, such as homes or sheds. Application system 110 may analyze map data 224 in order to distinguish between property area requiring maintenance and property area that does not require maintenance and thus that should not be included in the property area for a job request for the property. In other embodiments, application system 110 may provide a GUI to a client device enabling a user of client device 130 to manually select the property area within map data 224.

At fourth action 340 of method 300, application system 110 determines a price estimate for the property based on the property area estimated at third action 330. Application system 110 may adjust the price estimate based on features of the property such as a number and size of trees and bushes. In embodiments, application system 110 may utilize a standard price per square foot for property area, and add on additional cost per feature of the property requiring additional cost.

At fifth action 350 of method 300, application system 110 generates a job request for the property based on the price estimate and adds the job request to a job queue viewable by professional devices. In embodiments, application system 110 may decline to generate job requests for job requests under a certain threshold cost. Similarly, for job requests over a specified threshold cost, application system 110 may instead direct the job request to a human operator of application system 110 in order to confirm the cost of the job request.

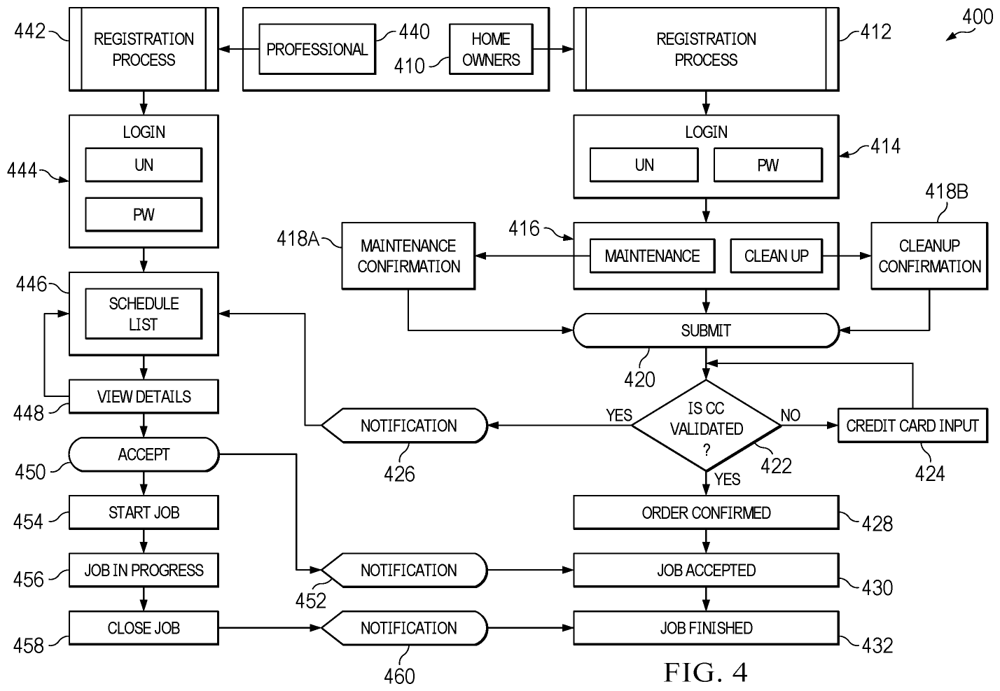

FIG. 4 illustrates exemplary method 400 for executing a maintenance work scheduling service application. Method 400 proceeds by one or more actions, which although described in a particular order, may be performed in one or more permutations, according to particular needs.

FIG. 4 defines two separate workflows for the application, home owners workflow 410 and professionals workflow 440. For home owners workflow 410, application system 110 at first action 412 performs a registration process, including obtaining a username and password, as well as a home owner name and a property address. Then, at second action 414 application system 110 performs a login process, where the home owner provides the username and password to log in. Then, at third action 416 application system 110 prompts the home owner for a required service, either maintenance or clean-up. If maintenance is selected, at fourth action 418A application system 110 presents a maintenance confirmation. If clean-up is selected, at fourth action 418B application system 110 presents a clean-up confirmation. From either fourth action 418A or 418B upon receiving confirmation application system 110 at fifth action 420 submits the confirmation.

Then, at sixth action 422 application system 110 determines if the home owner has a validated credit card. If not, at seventh action 424 application system 110 prompts the home owner to input a credit card. Then, upon validating the home owner credit card at sixth action 422, at eight action 426 application system 110 transmits a notification to professional devices of the service request. Then, at ninth action 428 application system 110 confirms the job request to the home owner. Thereafter, at sixth action 452 of professional workflow 440 application system 110 transmits a notification to the home owner when the job request is accepted by a professional, at tenth action 430. Following tenth action 460 of professional workflow 440 application system 110 transmits a further notification to the home owner when the job is completed, at eleventh action 432.

For professional workflow 440, at first action 442 application system 110 performs a registration process, including obtaining a username and password, as well as a professional name. Then, at second action 444 application system 110 performs a login process, where the professional provides the username and password to log in. Then, at third action 446 application system 110 displays a schedule list of job requests to the professional, allowing the professional to view the job requests, and choose to accept or decline the job requests. Application system 110 may transmit notifications to the professional when new jobs are added to the schedule list. Then, if the professional accepts the job request, at fourth action 448, at fifth action 450 a notification is transmitted to the home owner of the acceptance, at sixth action 452. Thereafter, the professional starts the job at seventh action 454, performs the job at eight action 456 and completes the job at ninth action 458. When the job is completed at tenth action 460, a further notification is transmitted to the home owner by application system 110.

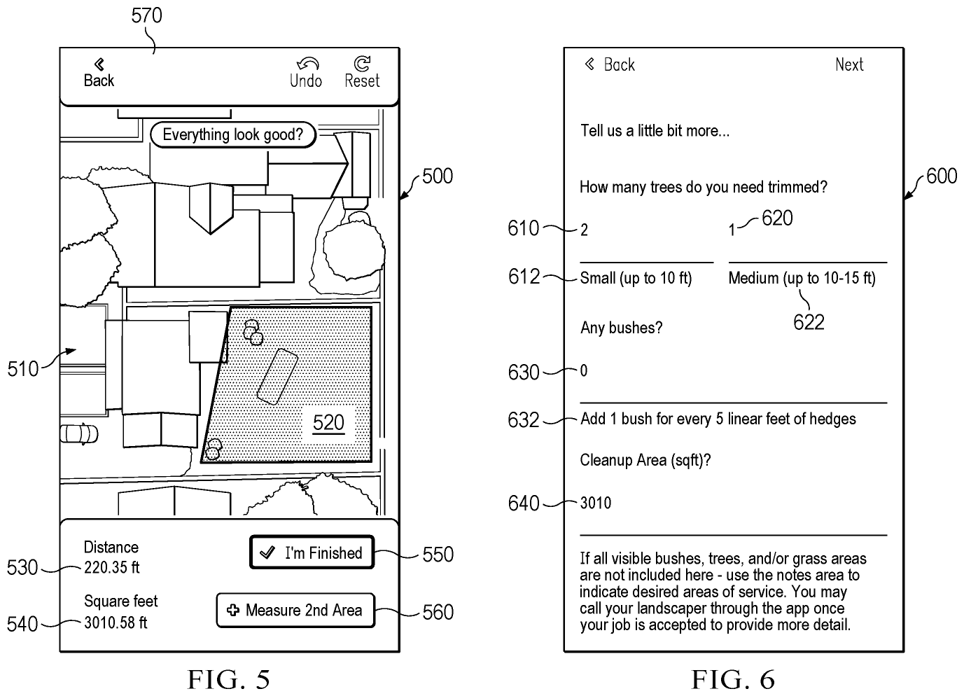

FIG. 5 illustrates area calculation screen 500 of the application according to an embodiment. Area calculation screen 500 includes base map data image 510 displaying parts of three properties. Over base map data image 510 is polygon 520 drawn to estimate the area of the property requiring maintenance. Area calculation screen 500 includes distance estimate display 530, showing the perimeter of the polygon, in this case 220.35 feet, and area estimate display 540, in this case 30310.58 feet. Area calculation screen 500 includes confirmation button 550 for confirming that the area estimation is correct, second area button 560 for adding second areas to the area estimation. Area calculation screen 500 further includes navigation buttons 570 for returning to the previous screen, undoing the last action (currently not selectable) and for resetting area calculation screen 500.

FIG. 6 illustrates property detail screen 600 of the application, according to an embodiment. Property detail screen 600 includes input form fields 610, 620 and 630 for inputting the number of small trees at 610, the number of medium trees at 620, and the number of bushes present at 630, as well as explanatory information for those form fields at 612, 622 and 632. Additionally, property detail screen 600 provides area correction field 640, for the user to correct the area estimate determined by the application at area calculation screen 500.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been shown and described, it will be understood that various changes and modifications to the foregoing embodiments may become apparent to those skilled in the art without departing from the spirit and scope of the present invention.

What is claimed is:

1. A computer-implemented method, comprising:
receiving, at an application system comprising a processor and memory and from a computing device associated with a customer, a request to register a property for landscaping services;
determining, by the application system, based on address input received from the computing device associated with the customer, map data associated with the property;
determining, by the application system, a service area associated with property based on the map data associated with the property;
calculating, by the application system, a landscaping service price estimate based on the service area associated with the property;
transmitting, by the application system, a job request including the landscaping service price estimate to a landscaping job queue; and
receiving, by the application system from a computing device associated with a landscaper, a confirmation to accept the job request.

2. The computer-implemented method of claim 1, further comprising:
receiving, at the application system from the computing device associated with the customer, an adjustment to the service area associated with the property; and
updating, by the application system, the landscaping service price estimate.

3. The computer-implemented method of claim 1, further comprising:
upon transmitting the job request, transmitting, by the application system to the computing device associated with the landscaper, a job notification.

4. The computer-implemented method of claim 3, further comprising:
upon receiving the confirmation to accept the job request, transmitting, by the application system to the computing device associated with the customer, a job acceptance notification.

5. The computer-implemented method of claim 4, further comprising:
determining, by the application system, that the landscaper has completed a landscaping service associated with the job request; and
transmitting, by the application system to the computing device associated with the customer, a job completion notification.

6. The computer-implemented method of claim 1, wherein the map data associated with the property comprises aerial photographs.

7. The computer-implemented method of claim 1, wherein the landscaping job queue comprises one or more additional job requests from additional customers, wherein the computing device associated with the landscaper is enabled to accept any of the one or more additional job requests.

8. A system comprising:
a computing device associated with a customer;
a computing device associated with a landscaper; and
an application system, the application system comprising a processor and memory and configured to:
receive, from the computing device associated with a customer, a request to register a property for landscaping services;
determine, based on address input received from the computing device associated with the customer, map data associated with the property;
determine a service area associated with property based on the map data associated with the property;
calculate a landscaping service price estimate based on the service area associated with the property;
transmit a job request including the landscaping service price estimate to a landscaping job queue; and
receive, from a computing device associated with a landscaper, a confirmation to accept the job request.

9. The system of claim 8, wherein the computer is further configured to:
receive, from the computing device associated with the customer, an adjustment to the service area associated with the property; and
updating the landscaping service price estimate.

10. The system of claim 8, wherein the computer is further configured to:
upon transmitting the job request, transmit, to the computing device associated with the landscaper, a job notification

11. The system of claim 10, wherein the computer is further configured to:
upon receiving the confirmation to accept the job request, transmit by the application system to the computing device associated with the customer, a job acceptance notification.

12. The system of claim 11, wherein the computer is further configured to:
determine that the landscaper has completed a landscaping service associated with the job request; and
transmit, to the computing device associated with the customer, a job completion notification.

13. The system of claim 8, wherein the map data associated with the property comprises aerial photographs.

14. The system of claim 8, wherein the landscaping job queue comprises one or more additional job requests from additional customers, wherein the computing device associated with the landscaper is enabled to accept any of the one or more additional job requests.

15. A non-transitory computer-readable storage medium embodied with software, the software when executed being configured to:
receive, at an application system comprising a processor and memory and from a computing device associated with a customer, a request to register a property for landscaping services;
determine, by the application system, based on address input received from the computing device associated with the customer, map data associated with the property;
determine, by the application system, a service area associated with property based on the map data associated with the property;
calculate, by the application system, a landscaping service price estimate based on the service area associated with the property;
transmit, by the application system, a job request including the landscaping service price estimate to a landscaping job queue; and
receive, by the application system from a computing device associated with a landscaper, a confirmation to accept the job request.

16. The non-transitory computer-readable storage medium of claim 15, wherein the software when executed is further configured to:
receive, at the application system from the computing device associated with the customer, an adjustment to the service area associated with the property; and
update, by the application system, the landscaping service price estimate.

17. The non-transitory computer-readable storage medium of claim 15, wherein software when executed is further configured to:
upon transmitting the job request, transmit, by the application system to the computing device associated with the landscaper, a job notification.

18. The non-transitory computer-readable storage medium of claim 17, wherein software when executed is further configured to:
upon receiving the confirmation to accept the job request, transmit, by the application system to the computing device associated with the customer, a job acceptance notification.

19. The non-transitory computer-readable storage medium of claim 18, wherein software when executed is further configured to:
determine, by the application system, that the landscaper has completed a landscaping service associated with the job request; and
transmit, by the application system to the computing device associated with the customer, a job completion notification.

20. The non-transitory computer-readable storage medium of claim 15, wherein the map data associated with the property comprises aerial photographs, wherein the landscaping job queue comprises one or more additional job requests from additional customers, wherein the computing device associated with the landscaper is enabled to accept any of the one or more additional job requests.
